(19) United States
(12) Patent Application Publication
(10) Pub. No.: US 2003/0004653 A1
(43) Pub. Date: Jan. 2, 2003

(54) Automated technology of screening of stationary phases

(76) Inventors: Michael Flavin, Darien, IL (US); Sreenivasarao Vepachedu, Palo Alto, CA (US); David Zembower, LaGrange, IL (US)

Correspondence Address: MCDONNELL BOEHNEN HULBERT & BERGHOFF, 300 SOUTH WACKER DRIVE, SUITE 3200, CHICAGO, IL, 60606, US

(21) Appl. No.: 10/087,102

(22) Filed: Mar. 1, 2002

Related U.S. Application Data
(63) Continuation-in-part of application No. 09/755,779, filed on Jan. 5, 2001.
(63) Continuation-in-part of application No. 09/737,204, filed on Dec. 14, 2000.
(63) Continuation of application No. 09/443,987, filed on Nov. 19, 1999, now Pat. No. 6,175,816.
(63) Continuation of application No. 08/862,840, filed on May 23, 1997, now Pat. No. 6,044,212.
(60) Provisional application No. 60/273,155, filed on Mar. 2, 2001.
(60) Provisional application No. 60/224,303, filed on Aug. 10, 2000.
(60) Provisional application No. 60/174,974, filed on Jan. 6, 2000.
(60) Provisional application No. 60/018,282, filed on May 24, 1996.

(51) Int. Cl. G06G 7/48; G06G 7/58; G06F 19/00; G01N 31/00

(52) U.S. Cl. 702/22; 562/402; 703/12

(57) ABSTRACT

A method and workstation for optimizing separation of a given racemate automation technology, and computer-controlled design is disclosed. The workstation includes a synthesizer, an analyzer, a robot and computer in communication with the synthesizer and analyzer. The computer includes one or more programs for regulating variables such as types of stationary phases; types of solvents; amounts of solvents; pressure; temperature; and employs methods for optimizing separation of a given racemate and for designing optimized experiments for further investigation.

### REFERENCE TO RELATED APPLICATIONS

The current patent application claims priority to U.S. patent application Ser. No. 60/273,155 filed on Mar. 2, 2001 and entitled “Automated Technology of Screening of Stationary Phases.” This application incorporates by reference U.S. patent application Ser. No. 60/273,155 in its entirety. The current patent application claims priority to U.S. patent application Ser. No. 60/224,303 filed on Aug. 10, 2000 and entitled “Method and Apparatus for Optimization of High-Throughput Screening and Enhancement of Biocatalyst Performance.” This application incorporates by reference U.S. patent application Ser. No. 60/224,303 in its entirety. The current patent application claims priority to U.S. patent application Ser. No. 60/174,974 filed on Jan. 5, 2000 and entitled “Combinatorial Approach to Kinetic Resolution of Chiral Molecules.” This application incorporates by reference U.S. patent application Ser. No. 60/174,974 in its entirety. This application also is a continuation in part of U.S. patent application Ser. No. 09/755,779 filed on Jan. 5, 2001, pending. This application incorporates by reference U.S. patent application Ser. No. 09/755,779 in its entirety. This application also is a continuation in part of U.S. patent application Ser. No. 09/737,204 filed on Dec. 14, 2000, pending, which is a continuation of U.S. patent application Ser. No. 09/443,987 filed on Nov. 19, 2000, now U.S. Pat. No. 6,175,816, which is a continuation of U.S. patent application Ser. No. 08/862,840 filed on May 23, 1997, now U.S. Pat. No. 6,044,212, which claims priority to U.S. patent application Ser. No. 60/018,282 filed on May 24, 1996. This application incorporates by reference U.S. Pat. Nos. 6,175,816 and 6,044,212. This application also incorporates by reference U.S. patent application Ser. No. 60/018,282.

### FIELD OF INVENTION

This invention relates to the use of automated technology in the high throughput screening of chiral stationary phases (CSPs) to identify an optimum CSP for the separation of a given racemate. This invention addresses two problems: 1) identifying a suitable CSP for a particular racemate and 2) identifying a suitable solvent system for chromatography using the selected CSP for the chiral separation of the given racemate.

### BACKGROUND OF THE INVENTION

One of the most convenient and accurate means of separating chiral compounds into their respective enantiomers is liquid chromatographic resolution on chiral stationary phases (CSPs). Many studies have been done on developing new and more efficient CSPs over the past several decades. One important goal still remains the same-to find CSPs which have the ability to separate a wider range of racemic compounds. Interest in the chemistry of chiral stationary phases has grown steadily over the past two decades, due to the increasing need for single enantiomer drugs. This is due to the fact that one enantiomer sometimes turns out to be highly toxic while the other enantiomer is effective. Many chromatographic techniques, especially high performance liquid chromatography (HPLC) with CSPs, have been used to achieve direct enantiomer separation. Most of the various CSPs used today in HPLC were developed and commercialized over the past two decades.

With the increase in understanding of interactions and modeling, CSPs can be designed and synthesized for optimum separation. Enantiomer separation is very easy when a column uses a CSP specific to a certain enantiomer. There are many products available today, commercial and from literature, where a promising CSP can be found for a particular separation.

Early chromatographers employed a limited number of readily available like adsorbents paper, wool, silk, alumina, silica etc to perform the separations. Today, researchers are faced with another problem. They are provided with a large number of commercially available separation materials. Even in the domain of chiral stationary phases there is a wide variety of commercial CSPs available. To complicate this, the use of combinatorial synthesis and exploration of new CSPs is becoming widespread recently. With so much varieties to choose from, the chemist is faced with a problem of selecting a suitable CSP for the separation of a given racemate.

There are several methods of screening of CSPs to find an optimum CSP for the resolution of a particular racemate. However, none of these methods are automated. Many of the initial efforts at screening of CSPs involve tethered analytes for the evaluation. One recent method employed by Regis Technologies Inc. involves incubation of the CSPs with a solution of racemate and investigating the supernatant solution for the selectivity. All these prior techniques are difficult for automation and repetition of the experiments.

### SUMMARY OF THE INVENTION

The present invention relates to a process of screening solid candidate selective adsorbants such as CSPs for differential adsorption of components of a mixture containing two or more components (analyte), for example, a racemic mixture.

In one embodiment, the method involves a process using multiple-well devices. In one embodiment, a fritted 96- or 48-well plate (SP Plate) is used. The multiple wells are loaded with distinct stationary phase. Thereafter, the stationary phase is covered. In one embodiment, the stationary phase is covered with a frit. A solution of the candidate mixture that needs to be separated is brought into contact with the stationary phases in the well device. In a preferred embodiment, the solution is transported using a liquid handler or any other suitable automatic liquid dispensing system. The solution is then allowed to drain gravitationally. In a preferred embodiment, a stacked multi-well plate structure is used wherein the SP Plate is positioned above a 96- or 48-well collection plate. Moreover, in a preferred embodiment, the environmental conditions, such as pressure and temperature, are predetermined.

The concentration change in the components of the analyte are then analyzed. In one embodiment, this is performed by either manually or robotically moving the collection plate to an analyzer (such as an HPLC system) and analyzing the components of the analyte. In an alternate embodiment, the analyzer is moved either manually or robotically to the collection plate.

Thereafter, the results from the analyzer are analyzed. In a preferred embodiment, the stationary phase showing the greatest selective adsorption is determined. The chemist may use the selected stationary phase which was shown in the original experiment to have the greatest adsorption. In an alternate embodiment, the chemist may use an iterative process whereby new experiments are chosen based on the best stationary phase or based on an analysis of some of the better stationary phases. In particular, other variables, such as choice of CSP, choice of solvent, solvent percentages, temperature and pressure may effect adsorption. These other variables may be varied in order to find optimal conditions for separation.

The manner in which to find the optimal conditions may be performed either manually or automatically. New experiments which include different values for the variables (such as different choice of CSPs, solvents, different solvent percentages, etc.) may be chosen for the next set of experiments. These different values for the variable may be determined in a variety of ways. In one embodiment, the different values may be chosen either automatically or manually based upon the stationary phase showing the greatest selective adsorption. For example, the CSPs in a first experiment may be analyzed to determine which is the best in terms of adsorption. CSPs may then be chosen for the next set of experiments based on characteristics which are common to the CSP which was judged best in the first set of experiments. As another example, the stationary phase showing the greatest selective adsorption will have a choice of solvent, solvent percentage, etc. For the next set of experiments, different solvents, which have similar properties to the solvent used in the original experiment, may be chosen. Moreover, solvent percentages which are in the range of the solvent percentage used in the original experiment may be chosen for the next set of experiments. Alternatively, solvent percentages which are chosen automatically at random may be used for the next set of experiments. Thereafter, the next set of experiments are run and the results, using the analyzer, are evaluated to determine the optimal conditions.

### BRIEF DESCRIPTION OF THE DRAWINGS

The following discussion will make reference to the accompanying drawing figures, wherein like reference numerals refer to like elements in the various views, and wherein:

FIG. 1 is a diagram of the components of a preferred workstation for implementing the invention.

FIG. 2 is a block diagram illustrating the flow of commands and data between the computer and synthesizer, robotic arm and product analyzer of FIG. 1.

FIGS. 3a-3c are perspective views of a well in the plate.

FIG. 4 is a cross section of the stationary phase plate and collection plate.

FIG. 5 is an additional block diagram of the computer, synthesizer, robot, and analyzer.

FIG. 6 is a flow diagram for an exemplary embodiment of the automated design of experiments.

FIG. 7 is a block diagram illustrating the computational analysis, particularly diversity analysis, used to evaluate a large library of potential CSPs.

FIGS. 8A-5F are an additional flow chart of the sequence of steps in performing the preferred optimization routine using the equipment of FIG. 1.

### DETAILED DESCRIPTION OF THE PRESENTLY PREFERRED EMBODIMENTS

A. System Overview

In this description, a novel apparatus and process is disclosed for screening solid candidate selective adsorbants such as CSPs for differential adsorption of components of a mixture containing two or more components (analyte), for example, a racemic mixture. In one embodiment, the stationary phase showing the greatest selective adsorption is determined by analyzing a single set of experiments. In an alternate embodiment, optimum conditions for the based on an iterative process using multiple sets of experiments. The iterative process may be performed either manually or automatically. Automatically, a machine may perform the repetitive procedures involved in process development in order to increase the efficiency with which data can be collected and analyzed.

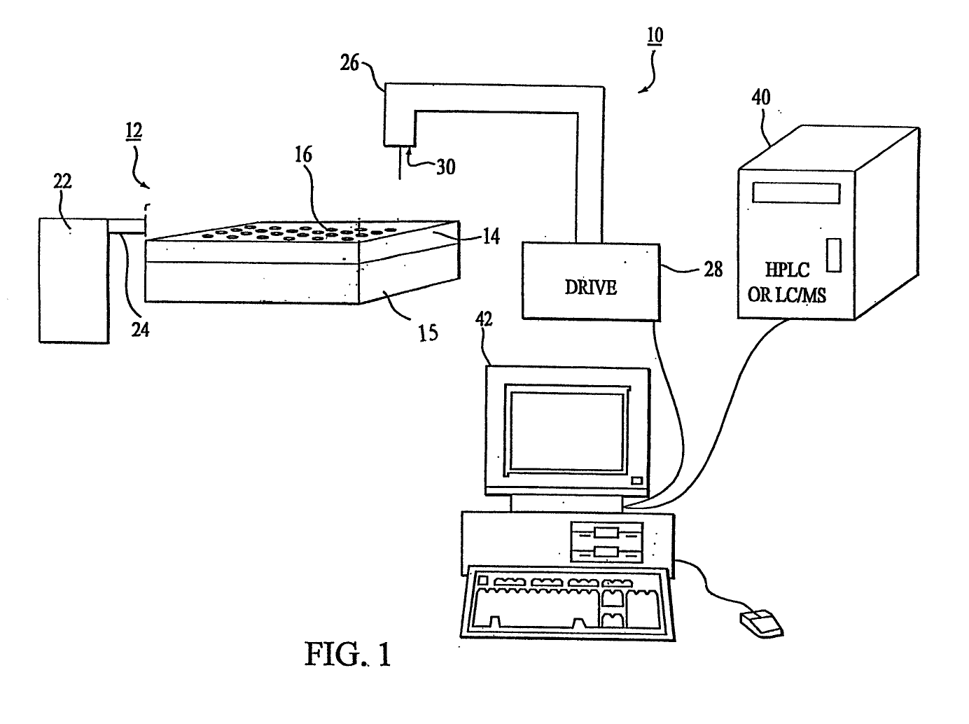

A preferred workstation for implementing the invention is shown in FIG. 1. The workstation 10 includes a synthesizer 12 having a block 14 and a block 15. In one embodiment, the synthesizer 12 is a liquid handler. Block 14 is a stationary phase (SP) plate and has, for example, 96 or 48 wells 16. Block 15 is a collection plate and is positioned below Block 14. Block 15 has, for example, 96 or 48 wells 17. Referring to FIG. 4, there is shown a cross-section of the stationary phase plate 14 and the collection plate 15. The stationary phase plate 14 has, in one embodiment, unique stationary phase in each of the wells (i.e., stationary phase which is different from well to well). The stationary phase in each of the wells is placed between a first fritt 52 and a second fritt 56. In one embodiment, the stationary phase plate is “recyclable,” containing a library of solid phases that can be integrated into an automated system. In particular, the packed stationary phase plate is reused again and again in order for efficient screening. Ease of use is one of the benefits of using a stationary phase plate that allows the use of prepacked stationary phase plates. The collection plate 15 is positioned below the stationary phase plate 14 such that the nozzles at the lower portion of the wells of the stationary phase plate 14 are approximately centered relative to the wells which are below in the collection plate 15. As discussed subsequently, solution dispensed into the SP Plate is allowed to drain gravitationally into the collection plate.

In experiments which require adjustment of the temperature, the synthesizer 12 may be equipped with a temperature control system for adjusting the temperature of the block 14, so as to control the temperature of the wells 16. In the present example, the Gilson 215 liquid handler was used. Preferably, the temperature control system has the capability of controlling the temperatures of the wells individually, so that the separation conditions in the wells 16 can be customized. A source 22 of nitrogen or argon gas is connected to the synthesizer 12 via a conduit 24, which enables a control of the atmospheric conditions above the wells.

The synthesizer 12 further includes a robotic arm assembly 26 which has pipetting capability for selectively adding quantities of a distinct stationary phase, frits, a solution of the candidate mixture into the wells 16, as discussed subsequently. The robotic arm assembly 26 includes an X-Y drive mechanism 28 or other suitable means for controlling the position of the pipetting tip portion 30 of the arm assembly relative to the wells.

In one embodiment, the analytical functions are performed by an analytical instrument 40 for conducting analysis of the products. The analytical instrument may include an HPLC system (for example, a chiral HPLC system). Alternatively, the analyzer may include a polarimeter.

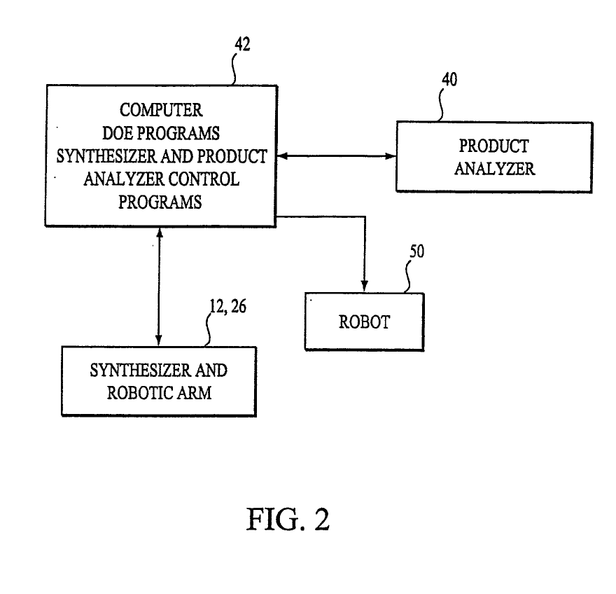

As discussed subsequently, samples from the collection plate can be either manually loaded into the analytical instrument 40, or loaded automatically with the assistance of suitable robotic arms or other equipment, represented by robot 50 in FIG. 2 or other suitable mechanical system.

The operation of the synthesizer 12 and analytical instrument 40 may be controlled by a computer 42, as shown in the block diagram of FIG. 2. The computer 42 regulates the environmental conditions in the synthesizer 12 such as by controlling the temperature of the wells 16. The quantity and type of components added to the wells are also controlled by the computer 42, as is the position of the arm 26 relative to the wells 16. The computer 42 further initiates and controls the analysis in the analytical instrument 40, and receives the analytical data from the instrument 40. In one embodiment, the computer 42 further implements a design of experiment program (DOE) that is used to identify the optimal separation conditions or parameters, as described below. It will be understood that some or all of the control functions of the computer 42 may be integrated into one or more of the individual components of the system 10. Where the products are automatically loaded into the product analyzer 40, the computer 42 controls a robot 50 to perform this task.

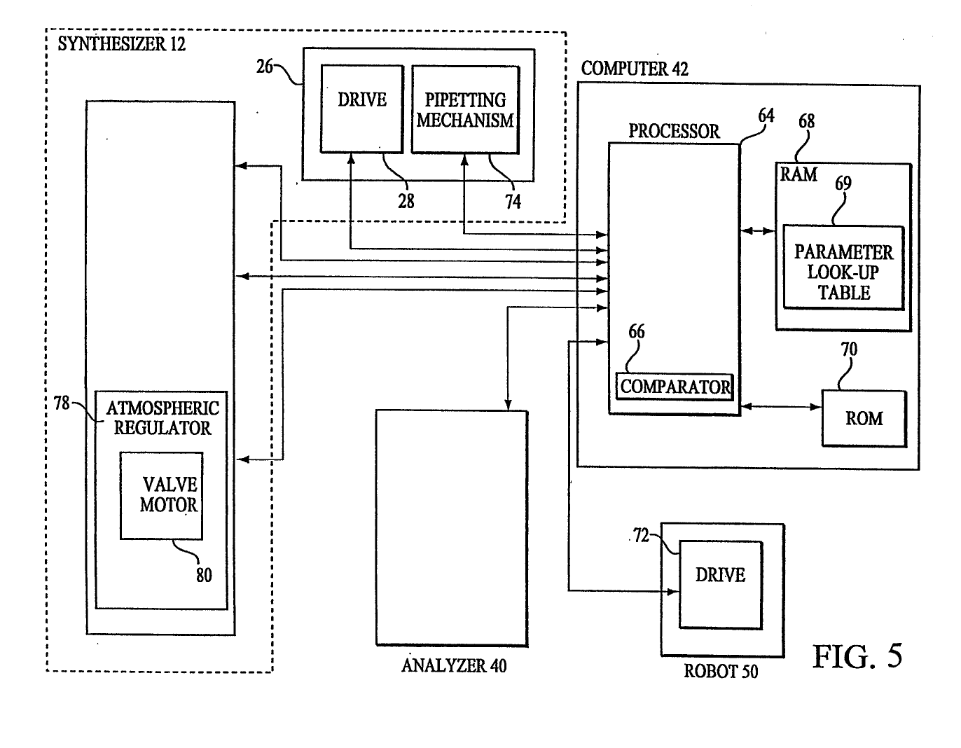

An additional block diagram of the computer, synthesizer, robot, and analyzer is shown in FIG. 5. The computer 42 contains a processor 64 which communicates with non-volatile (read only memory, ROM 68) and volatile (random access memory, RAM 70) memory devices. The processor 64 also has a comparator 66 for comparing values. The processor 64 executes a computer program. The computer program is stored in the ROM 68 and executed either in the RAM 68 or the ROM 70.

The processor 64 communicates with various subcomponents of the synthesizer 12, the analyzer 40 and the robot 50. The synthesizer, in one embodiment, contains a temperature control system which controls the temperature of each of the individual wells of the block. The processor sends a command to the temperature control system specifying a certain temperature for a particular well.

The synthesizer also may contain an atmospheric regulator 78 which protects the components in the wells if the components are sensitive to oxygen or water or other materials in the environment in proximity to the well. Nitrogen or argon gas is dispensed from the source 22 through the conduit 24 based on a valve which is controlled by the valve motor 80. The valve motor is controlled by the processor 64.

The synthesizer further contains a drive 28 for moving the robotic arm assembly 26. As described above, the robotic arm assembly 26 has pipetting capability for selecting, obtaining and dispensing one or more components. The pipetting capability is performed through a pipetting mechanism 74 which draws components through the pipetting tip portion 30 and stores one or more components in the robotic arm assembly 26. Subsequently, the one or more components are dispensed via the pipetting mechanism 74 into the wells. Both the drive 28 and the pipetting mechanism 74 are controlled by the processor 64.

The analyzer 40 and robot 50 are in communication with the processor 64 as well. The processor 64 controls the drive 72 of the robot 50 which extracts samples from each of the wells. The samples are transferred to the analyzer 40 which analyzes one aspect of the mixture including the product, the reactants, and any contaminants. Alternatively, a robotic arm may move the analyzer so that the analyzer may examine the sample or the robotic arm may extract samples and place the samples in a separate well-block for off-line analysis.

B. Methodology

The following is a method according to one embodiment of the present invention.

Step 1:

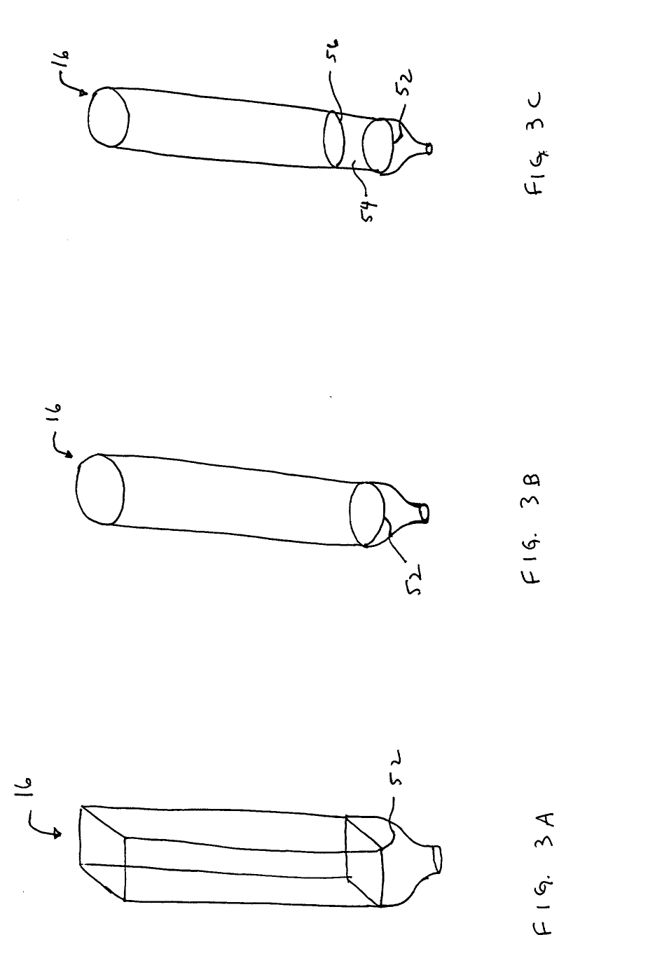

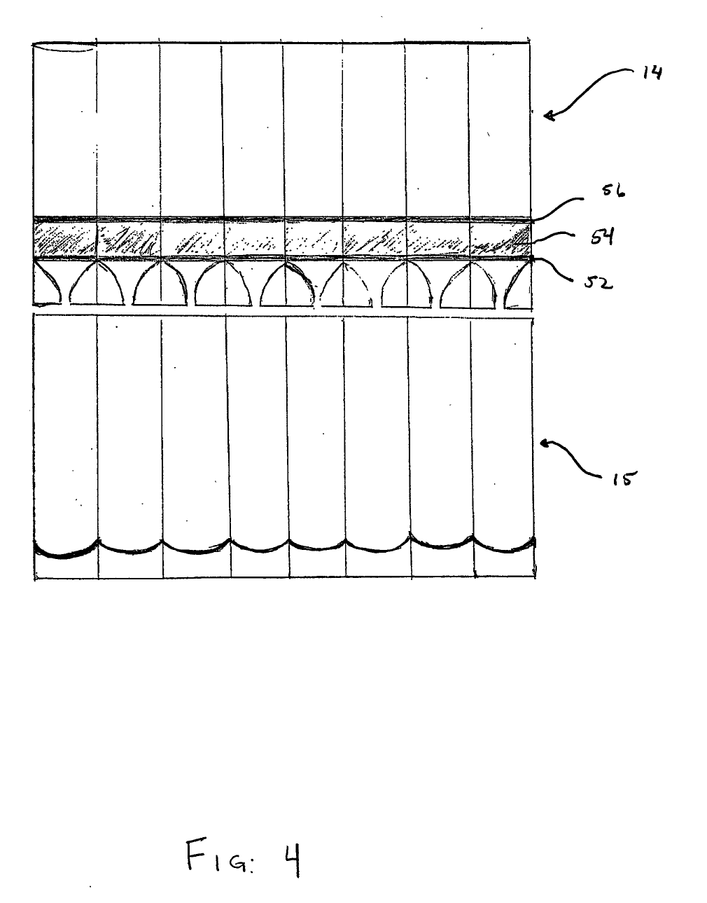

In this process, a fritted 96- or 48-well plate (SP Plate), plate 14 in FIG. 1, is loaded with a suitable amount of a distinct stationary phase (SP) in each well. Then the stationary phase in the well is covered with another frit snugly just above the stationary phase. FIGS. 3A and 3B show perspective views of two individual wells in the well plate. A first fritt 52 is placed at the lower portion of the individual wells 16. Stationary phase 54 is added to the individual wells and a second fritt 56 is added, as shown in FIG. 3C.

Step 2:

Using a liquid handler or any other suitable an automatic liquid dispensing system, a solution of the candidate mixture that needs to be separated is brought in contact with the stationary phases in the SP Plate 14.

Step 3:

The solution thus dispensed into the SP Plate 14 is allowed to drain gravitationally into a 96/48-well collection plate (collection plate) 15 placed under the SP Plate 14.

Step 4:

Then the collection plate 15 is moved either robotically, using robot 50, or manually to a system that would detect the concentration change in the components of the analyte, e.g., an HPLC system (see block 40 in FIG. 1) to analyze. The gravitational filtration of the analyte through the stationary phase results in equilibration and/or interaction with the stationary phase. This interaction results in a change in the concentration of the one of the components of the analyte mixture.

Step 5:

The stationary phase showing the greatest selective adsorption is selected. At this juncture the analytical chemist may either use the selected stationary phase for the separation of the given mixture or studies further to find optimum conditions for separation, i.e., further studies for the solvent effects (alternatively, one may iterate to determine a better CSP, as discussed subsequently).

Step 6:

An SP Plate 14 containing the selected stationary phase in all the wells is prepared as in the step 1 and placed in a liquid handler. The analyte is dissolved in 96 or 48 different solvent systems and steps 2 through 4 are repeated, i.e., the analyte is dispensed using the automated liquid dispensing system into each well of the SP plate and allowed to gravitationally filter down into the collection plate, placed under the SP plate. The collection plate is then removed to an analytical system that would detect the concentration change in the components of the analyte.

Step 7:

The best solvent system that shows the greatest selection for one of the components is selected. At this juncture the analytical chemist has an option to either proceed with the separation of the mixture using the selected stationary phase and the selected solvent system or repeat the above steps 2 through 7 to find a better stationary phase using the information obtained at each step. The process may be repeated until the analytical chemist is satisfied with the results.

Automated Design of Experiments

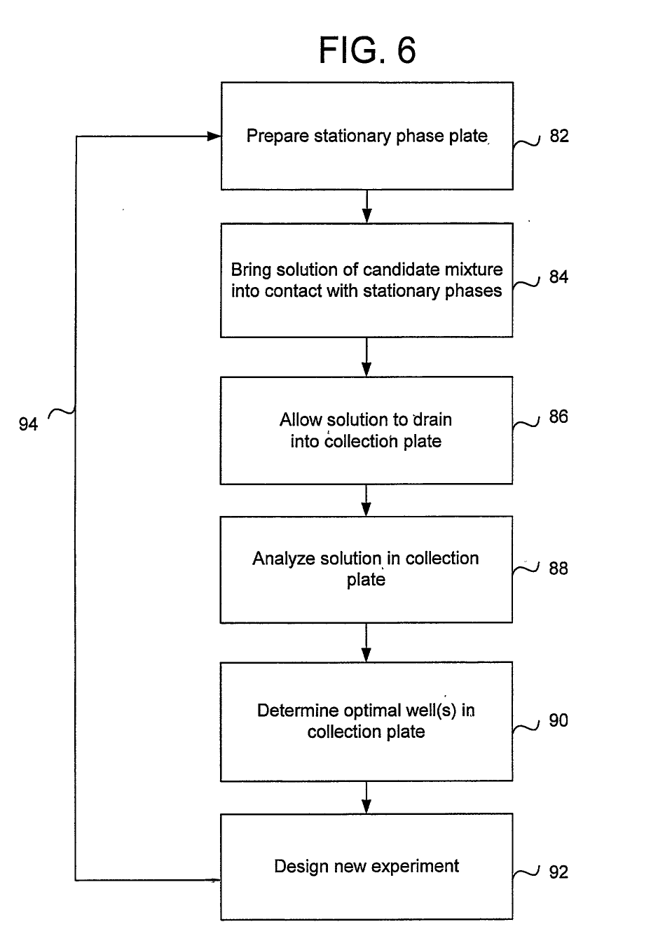

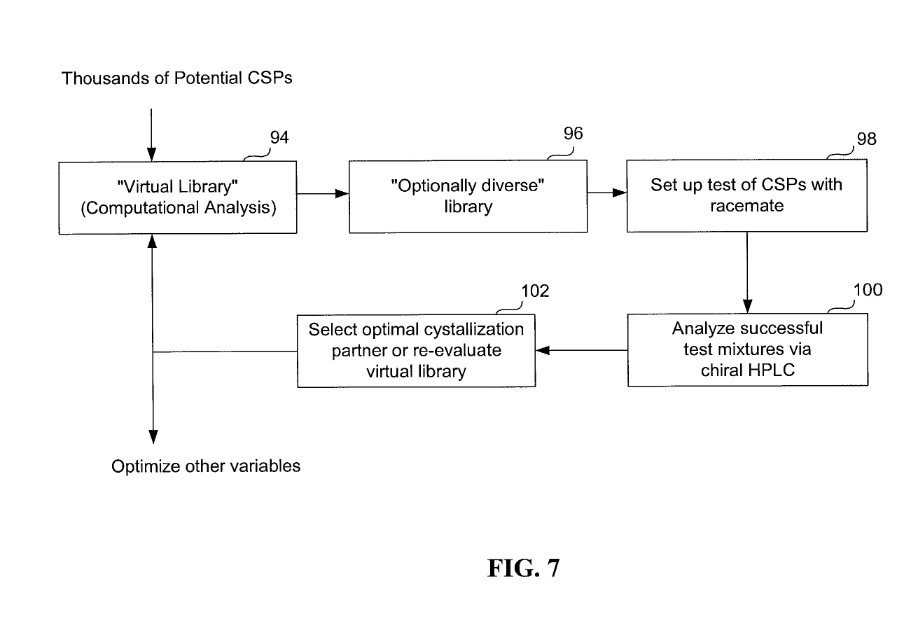

In one embodiment, the analytical chemist may use design of experiments (DOE) in order to find a better stationary phase and better solvents, percentage solvents, etc. Referring to FIG. 6, there is shown a flow diagram for an exemplary embodiment of the automated design of experiments. Referring to block 82, the stationary phase plate is prepared. In one embodiment, the automated design of experiments is an iterative process wherein values for the first set of experiments are chosen and values for the subsequent experiments are generated automatically. The values for the first set of experiments (in step 1, as defined above) may be chosen through a variety of ways. For example, the values may be chosen manually by the operator. Alternatively, given the range of values for the variables, the values for each of the 96 initial experiments may be chosen randomly or periodically with the range of values available. The different variables in the set of experiments include: the choice of stationary phase, the choise of solvent(s); the percentage of solvent(s); the pressure; the temperature; the addition rate (rate at which the racemic mixture is added); etc. For example, a random selection of solvents or a random selection of percentage of solvents may be used in the initial experiments. In one embodiment, the initial stationary phases that are placed in the wells are of different values (i.e., all of the wells have different stationary phases).

Thereafter, experiments may be performed, as done in steps 1-3, and the results may be evaluated, as done in step 4 using an analyzer 40. Referring to block 84, the solution of the candidate mixture is brought into contact with the stationary phases. The solution is allowed to drain in the collection plate, as shown at block 86. At this point, the results are compiled and analyzed, as shown at block 88. In one embodiment, in order to design the next set of experiments, the data compiled in step 4 is analyzed to determine common characteristics of a desired response. The analysis determines, based on the data, common characteristics within the set of experiments and is performed automatically by the computer 42. For example, if the data compiled in step 4 ranks the samples from best to worst, the analysis would determine the common characteristics of the better samples. Moreover, once a statistical analysis of the data is performed, the statistical analysis is then transferred (either manually or automatically) to a means for designing the next set of experiments. Thereafter, the values for the new set of experiments (including the stationary phase(s) used, the type(s) of solvents, the percentage(s) solvents, the temperature, the pressure, the addition rate, etc.) are chosen, as shown at block 92. The concept of statistical design of experiments (DOE) may therefore be applied to aid in experimental design. In one embodiment, the stationary phase showing the greatest selective adsorption is chosen as the stationary phase to be placed in all of the wells in the stationary phase plate for the next set of experiments. The types of solution and percentages of solution may then be varied. Alternatively, the top four (or some other number) of stationary phases showing the best selective adsorption may be chosen to be placed in the stationary phase plate for the next set of experiments, with other variables (such as types of solvents, and percentages of solvents, etc.) being varied as well. In still an alternate embodiment, the characteristics of the “best” stationary phase(s) in the first set of experiments may be analyzed, and similar stationary phases may be selected for the next set of experiments. For example, there are thousands of potential stationary phases available. These stationary phases may be classified by their characteristics. Some characteristics include, but are not limited to, the following: hydrophobic, hydrophilic, basic, acidic, neutral, polar, non-polar, etc. A specific stationary phase may be classified by one or more of the above characteristics. In a first set of experiments, the characteristics of a stationary phase showing the greatest selective adsorption may be analyzed to select additional stationary phases for future experiments. For example, if a specific stationary phase showing the greatest selective adsorption is hydrophobic, other stationary phases which are characterized as hydrophobic may be selected for further experimentation. Likewise, if a stationary phase which shows the greatest selective adsorption is classified as a combination of characteristics (for example, hydrophobic and basic), other stationary phases with similar characteristics (such as hydrophobic, basic or hydrophobic and basic) may be selected for further experimentation. The classifications of the stationary phases may be stored in a look-up table in ROM 68 and may be accessed by processor 64 to determine the stationary phases for the next set of experiments.

Moreover, other variables in the experiments may be varied for the next set of experiments. For example, the pressure is typically not adjusted during experimentation and the separation is performed using gravity. However, pressure may be adjusted to determine whether selective adsorption is increased. As another example, the temperature of the experiments is typically at room temperature. Likewise, the temperature may be adjusted to determine whether this affects the selective adsorption. Alternatively, the temperature may be maintained at constant temperature (e.g., room temperature). As still a further example, the addition rate may be modified to determine whether this affects selective adsorption. As shown in FIG. 5 with arrow 94, the process is iterative.

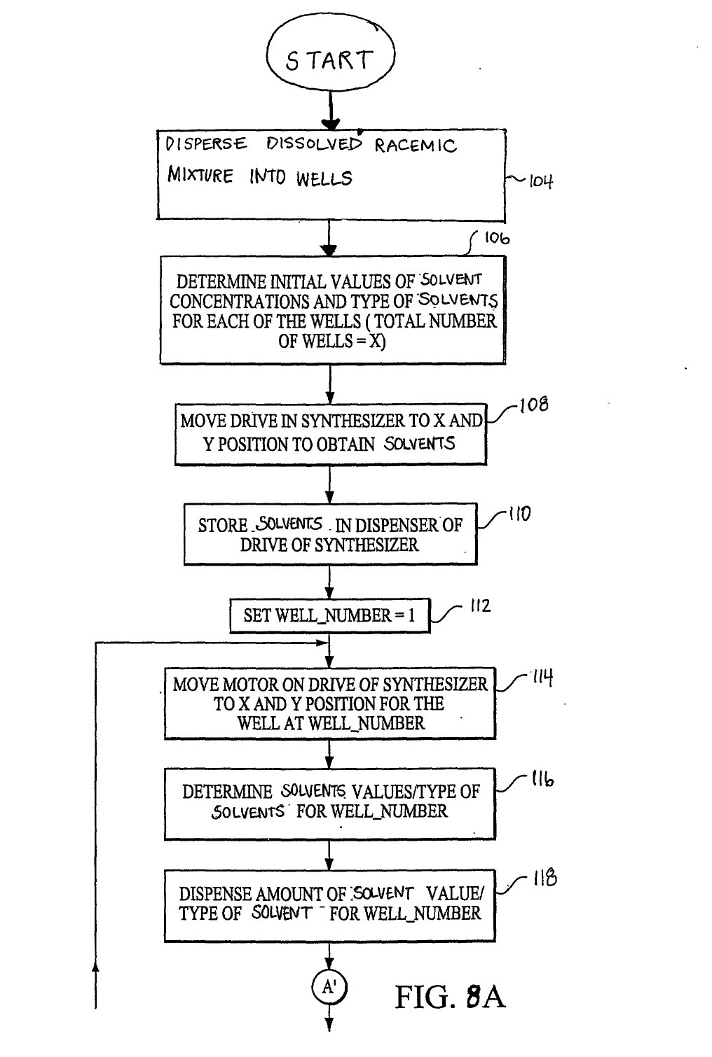

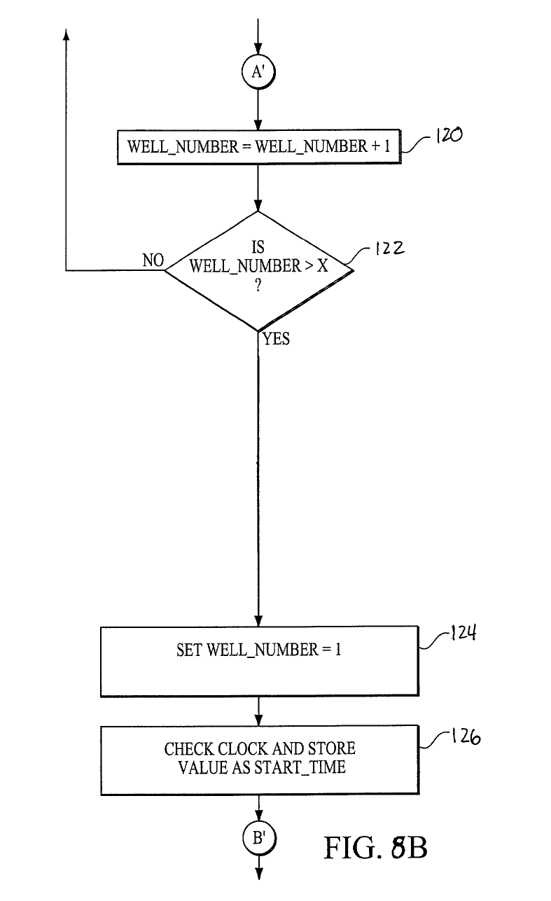

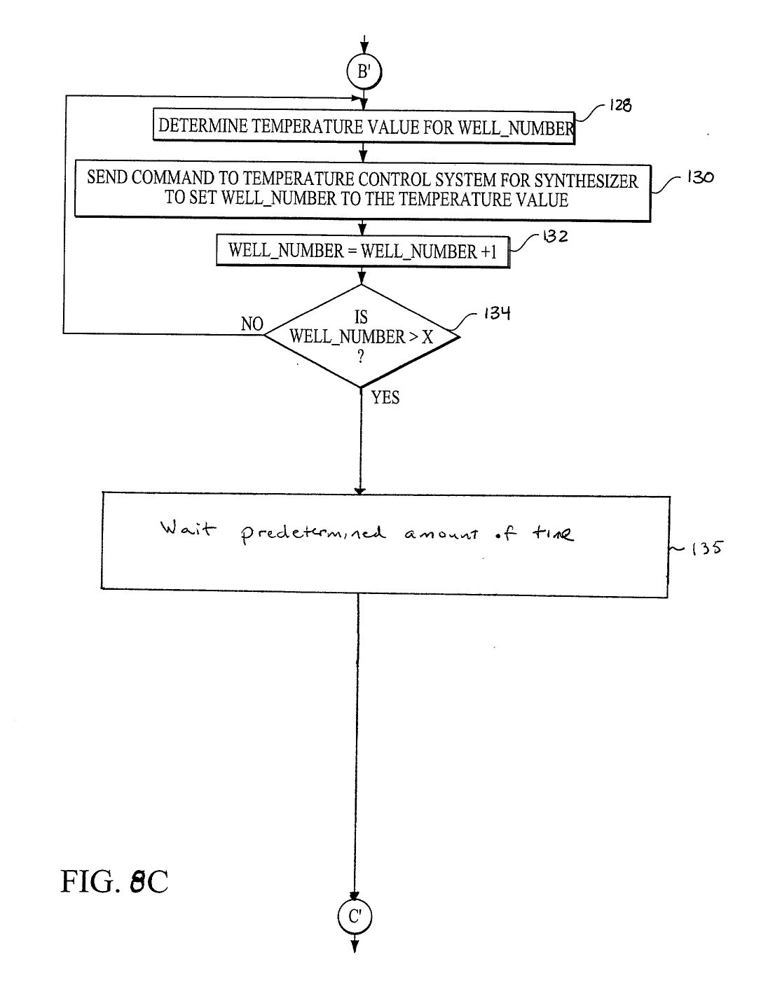

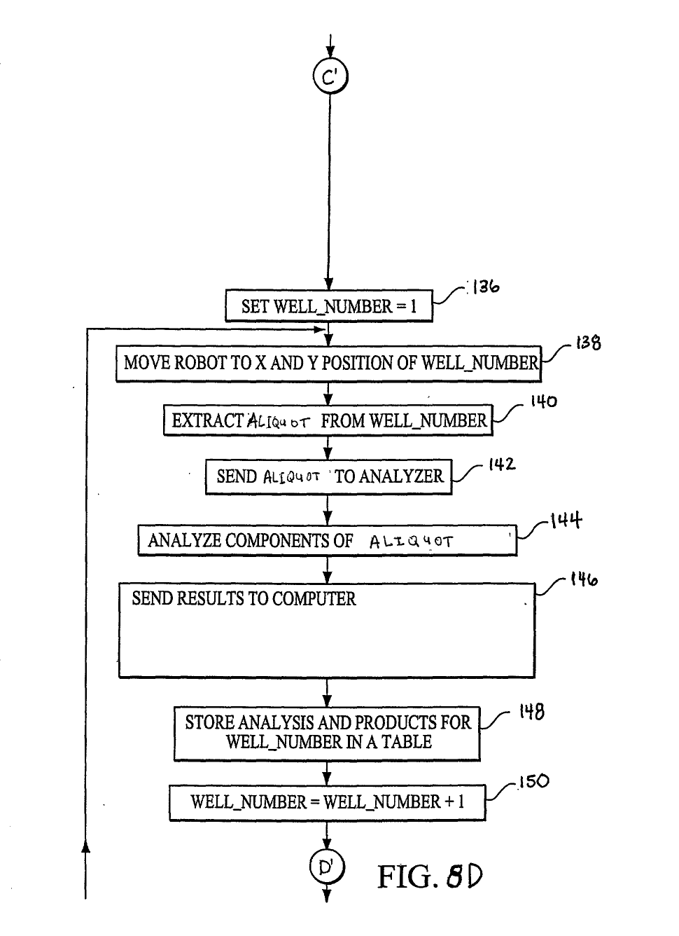

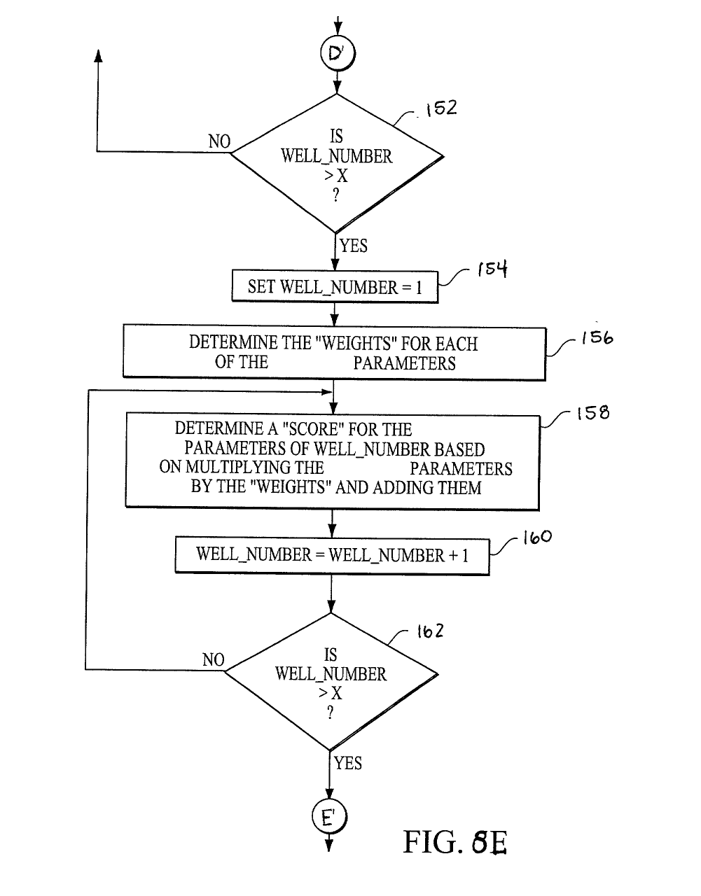

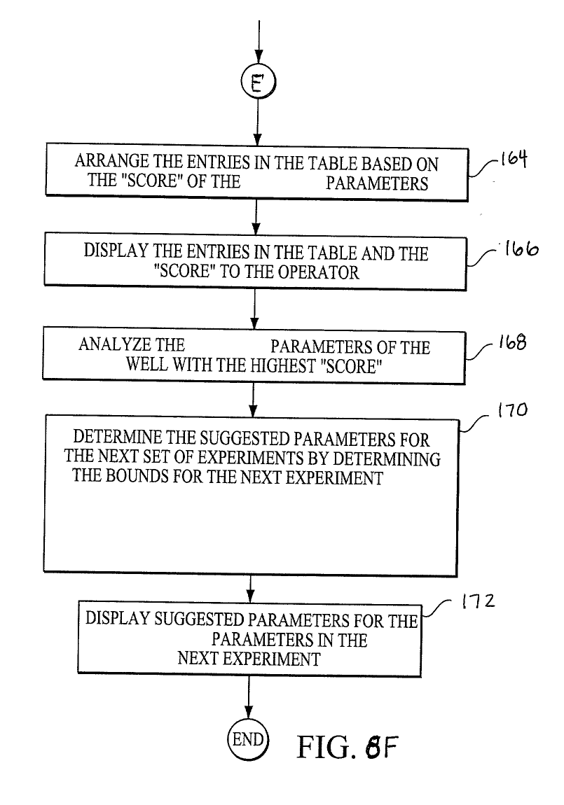

Referring to FIG. 7, there is shown a flow diagram for an alternate embodiment of the automated design of experiments. Specifically, FIG. 7 is a block diagram illustrating the computational analysis, particularly diversity analysis, used to evaluate a large library of potential CSPs. An optimal CSP is first determined, from the potential CSP library. Thereafter, optimal values for other variables (e.g., solvents, solvent percentages, etc.) are found, as discussed subsequently with respect to FIG. 8A-8F. Referring to block

Computational analysis, particularly diversity analysis, may be used to evaluate a large “virtual library” of potential CSPs, as shown at block 94 in FIG. 7. For example, the structures of thousands of CSPs may be analyzed using a commercial software application called Diversity Analyzer (which is manufactured by Molecular Simulations, Inc. in San Diego, Calif.), which compares the thousands of CSPs and provides an output that describes how “similar” or “different” they are with respect to one another. One may then select a smaller library, perhaps containing 100 of the CSPs, that fairly represents all sections of “diversity space”, as shown at block 96 in FIG. 7. Thus, in this example, the 100 selected CSPs would be loaded in each well. Further, the dissolved racemic mixture is added to the wells, and thereafter solvent is added, as shown at block 98 in FIG. 7. Typically, when attempting to determine the optimal CSP, the solvents for placed in each of the wells is not varied.

After an appropriate time period, aliquots are removed from the collection plate 15 and analyzed using an analyzer (such as a chiral HPLC analyzer), as shown at block 100. The enantiomeric purity of the samples removed from the collection plate is determined. If the sample is completely pure from an enatiomeric basis, one may determine that the optimal CSP has been found, as shown at block 102. Alternatively, one may determine the aliquot with the best enatiomeric purity and evaluate the virtual library in order to generate suggested CSPs for future experiments. For that CSP which produced the best enatiomeric purity, alternate CSPs may be chosen (based on design of experiments) in order to iterate to determine the optimal CSP to produce enatiomeric purity. As discussed above, CSPs may be classified based on certain characteristics. The characteristics of the CSP which produces the best enatiomeric purity may be matched with other potential CSPs in order to generate suggested CSPs for the next set of experiments. Alternatively, the structure of the CSP which produces the best enatiomeric purity may be analyzed and CSPs with similar structures may be used for the next set of experiments. Thus, using the “virtual library” that was constructed with the example thousands of potential CSPs discussed above, a more focused set of CSPs can be selected that occupy similar “diversity space” as the CSP(s) that were successful in achieving resolution. This focused set of CSPs would then be used to further optimize the resolution, using the same process as described for the initial test mixtures. Based upon this analysis, the optimal CSP may be found.

Once an optimal CSP is found, one may then optimize the other variables, such as choice of solvent, solvent percentages, etc. Referring to FIG. 8A-8F, there is shown an additional flow chart of the sequence of steps in performing the preferred optimization routine. The program which executes the operation of the automated sequence of operations, as stated above, is resident either in RAM 68 or ROM 70. As shown at block 104, the dissolved racemic mixture is dispersed into the wells. The racemic mixture may be dissolved in a small amount of solvent. Thereafter, the program determines the initial values of solvent concentrations and choice of solvents for the experiments. This is done so that the processor 64 can command the pipetting mechanism 74 to obtain the correct solvents and the appropriate amount of solvents for use in all of the wells. As shown in FIGS. 8A-5F, the total number of wells is designated as “X.” As discussed above, one block 14 has, for example, 48 wells 16. Blocks with less or more wells may be used as well.

The processor 64 then instructs the drive 28 to a particular x and y position to obtain the solvents, as shown at block 108. The pipetting mechanism 74 then stores the solvents in the dispenser of the drive of the synthesizer 12, as shown at block 110 of FIG. 5. Then a loop is executed for each of the wells 16, with the well_number set equal to 1as shown at block 112 of FIG. 5. The processor 64 moves the motor of the drive 28 to the x and y position of the well, as shown at 114, the solvent values and type of solvent is determined by the processor, as shown at 116, and the solvents are dispensed into the well, as shown at block 118 of FIG. 8A. The solvent values and type of solvents are determined by a parameter look-up table 69 (which contains all of the relevant parameters for the experiment) in the memory of the microprocessor. The component values and type of components are either based on operator input or based on the optimization scheme described subsequently. The well_number is incremented by 1, as shown at block 120 of FIG. 8B. If the well_number is greater than the total number of wells (X), then the loop is exited, as shown at block 122 of FIG. 8B. Otherwise, the flow chart of FIG. 8A goes to block 114. Alternatively, rather than automatic obtaining and dispensing of the solvents, the operator may manually input the solvents into the wells.

The well_number is set equal to 1, as shown at block 124 of FIG. 8B. Then, the clock for the processor 64 is checked with the value stored as the start_time of the experiment, as shown at block 126. A loop is then entered to set the temperatures of each of the wells. The temperature is determined for each well (block 128) by the parameter look-up table 69. The temperature in the parameter look-up table 69 is either based on operator input or based on the optimization scheme described subsequently. The processor 64 sends a command to the temperature control system 18 to set the temperature value, as shown at block 130. The well_number is incremented by 1, as shown at block 132 of FIG. 8C. If the well_number is greater than the total number of wells (X), then the loop is exited, as shown at block 134 of FIG. 8C. Otherwise, the flow chart of FIG. 8C goes to block 128. Typically, the temperature of the wells is held at room temperature; however, one may modify the temperature if it is believed to assist the separation of a given racemate. A predetermined amount of time is then waited, as shown at block 135.

The well_number is set equal to 1, as shown at block 136 of FIG. 8D. The processor 64 signals the drive 72 of the robot 50 to move to an x and y position (block 138), extract an aliquot from the well (block 140), and send the aliquot to the analyzer (block 142). The analyzer 40 then analyzes the components of the aliquot, as shown at block 144, and sends the results to the processor 64. In one embodiment of the invention, at least one component from each of the wells 16 is removed, sent to the analyzer 40 and analyzed. For example, if optimization of chiral resolution is desired, aliquots of the solution in the wells in the collection plate 15 is analyzed to determine the magnitude of chiral resolution. One method for determining the magnitude of chiral resolution is measuring the amount of optical rotation. This may be performed by a polarimeter. Alternatively, a chiral HPLC machine may be used to determine the amount of chiral resolution.

The processor 64 examines the data from the analyzer 40, as shown at block 146. Some analyzers perform this look-up table function itself and send the list of products back to the processor. The processor stores the analysis in a newly-created table, as shown at block 148, and continues obtaining data for each of the wells. The well_number is incremented by 1, as show at block 150 of FIG. 8D. If the well_number is greater than total number of wells (X), then the loop is exited, as shown at block 152 of FIG. 8E. Otherwise, the flow chart of FIG. 8D goes to block 138.

The newly created table is then analyzed by the processor 64 in order to determine the suggested parameters for the next experiment. Using a program which utilizes the Monte Carlo method, for instance, the operator can define the space of parameters to be analyzed, run a series of random preliminary experiments in this space, define a new space of parameters using the best of these preliminary experiments, run additional experiments in the new space and continue this process until no further improvement is observed. For example, the operator defines a space of parameters for each experiment such as solvent ratios or concentrations, and then performs several preliminary random experiments using the synthesizer. The analyzer data based on separation of the racemic mixture are then stored in the computer as a parameter. Based on the preliminary parameters and the separation parameter, the program then utilizes the statistical method to generate a new space of parameters (e.g., choice of solvents, solvent percentages, etc.) for further experimentation. A new set of experiments are then performed with the new space of parameters and the result is then stored and processed by the Monte Carlo method as before. This process can be repeated until no further improvements in enatiomeric purity, for instance, are obtained.

Alternatively, a program which utilizes the SDO method generates a set of experiments in all of the variables of interest for the operator. When these experiment has been run, the experiment that gave the worst result is identified among the set. This experiment is then discarded and replaced with a new experiment. When the replacement experiment has been run, the worst of the set is again identified and discarded. This process continues until no further improvement is observed. For example, the operator performs preliminary experiments with the synthesizer using SDO variables of interest. For example, the enatiomeric purity data, in combination with the variables, are then analyzed by the program. The program would then eliminate the experiment with the worst result, e.g., worst enatiomeric purity, and generate a new proposed experiment. This process is repeated until no further improvements are obtained. Alternatively, if the determination of “success” or “failure” is solely based on enatiomeric purity, the experiment with the lowest purity is discarded and generate a new experiment.

Another method to analyze the data in the newly created table is by first determining the “weights” for each of the parameters, as shown at block 156. The parameters include, for example, the choice of solvents, the solvent percentages, the pressure and the temperature, for example. Prior to execution of the program, the operator assigns “weights” based on importance of each parameter. In this manner, the results of each of the wells can be assigned a total “score” by multiplying the parameters by the “weights” and adding them. Each of the results for an individual well can then be tallied, as shown at block 158. The well_number is set equal to 1, as shown at block 154. The well_number is incremented by 1, as shown at block 160 of FIG. 8E. If the well_number is greater than the total number of wells (X), then the loop is exited, as shown at block 162 of FIG. 8E. Otherwise, the flow chart of FIG. 8E goes to block 158. For parameters which are more desirable when they are lower in value, the result of multiplying the weight by the parameter can be inverted, and then added to the total to determine the “score.”

The entries can then be arranged based on the score, as shown at block 164. The processor 64 then displays the results of the raw data and the “scores,” as shown at block 166. At each step in the methodology, the display can be updated to inform the operator of the current experiment. For example, when the processor 64 commands or receives information from the synthesizer 12, the analyzer 40 or the robot 50, the display can be updated to indicate the current operation.

Based on the highest ranked “score,” the suggested bounds for the next set of experiments are determined 168, 170. For example, if the temperature of the crystallization is determined to be an important parameter, the temperature value of the highest ranked “score” is used as a base value for the temperature bounds for the next set of experiments. The suggested parameters is then displayed to the operator, as shown at block 172.

Commercially available computer programs can control the conditions utilized by the synthesizer, perform statistical analyses and design the next set of experiments to conduct the most effective DOE study. One such program is Design Expert by Stat Ease Corp. in Minneapolis, Minn., which uses a linear regression analysis. Specifically, the computer program can analyze the data obtained from the analyzer to generate common characteristics from the data (such as linear regression analysis). For example, where the optimal choice of solvents and solvent percentages are sought, the computer program may analyze, for a given stationary phase, the experiments with the most selective adsorption (i.e., selecting the top five experiments and analyze the solvents used and the solvent percentages). Based on this analysis, the computer program may suggest a new set of experiments in order to determine the optimal values for the choice of solvents and solvent percentages. Alternatively, the computer program may determine the “best” (based on established criteria) sample, or to determine the “worst” sample. The computer 42 can then correlate the data obtained and extrapolate to propose new experiments. The system may then iterate to subsequently confirm the proposed optimal conditions. Specifically, the computer program can take the common characteristics generated from the statistical analysis and propose new experiments based on the trends. Alternatively, the computer program can design a new set of experiments localized around the components/conditions of the “best” sample. Basically, a new and potentially more narrowly circumscribed set of parameters (including types of components, concentrations of components, or environmental conditions) are programmed in the synthesizer and robotic arm, and the process is repeated. This procedure could iterate several times, until the optimal conditions are determined with the desired level of precision. Alternatively, the procedure could just be performed once, with the computer 42 identifying which of the wells 16 had the most favorable conditions.

Several types of methodologies may be used to design the next set of experiments including the Monte Carlo method, the SDO method, and the “weights” method. Using a program which utilizes the Monte Carlo method, for instance, the operator can define the space of parameters to be analyzed, run a series of random preliminary experiments in this space, define a new space of parameters using the best of these preliminary experiments, run additional experiments in the new space and continue this process until no further improvement is observed.

Alternatively, a program which utilizes the SDO method generates a set of experiments in all of the variables of interest for the operator. When these experiments have been run, the experiment that gave the worst result is identified among the set. This experiment is then discarded and replaced with a new experiment. When the replacement experiment has been run, the worst of the set is again identified and discarded. This process continues until no further improvement is observed. For example, the operator performs preliminary experiments with the synthesizer using SDO variables of interest. The data, in combination with the variables, are then analyzed by the program. The program would then eliminate the experiment with the worst result and generate a new proposed experiment. This process is repeated until no further improvements in product yield, for instance, are obtained.

This automated process development technology allows a vast array of data to be collected and interpreted. Many combinations of variables can be investigated in a short time period. Optimization using manual techniques may only find a local optimization or may be too time consuming. With the new automated technology presented here, a large number of statistical data points can be collected. In essence, a global optimization is found. The amount of data generated by this process is limited only by the number of variables that can be envisioned for a given experiment.

Automated Process Research coupled with statistical design of experiments is a useful tool for the identification of a better stationary phase and better solvents, percentage solvents, etc.

### EXAMPLE AND DISCUSSION

### Example 1

### Automation Of Chiral Stationary Phase (CSP) Screening

Introduction: This is an example of the work to automate the process of CSP screening to allow rapid screening of hundreds of CSPs efficiently and increase the speed of ChiralSelect™ services.

Results and Discussion

Standards A and B: A stock solution of racemate NEA pivalamide (12.75 mg) was prepared by dissolving in hexane (10 mL) by sonication. Standard A solution was prepared by diluting the stock solution to 5×10⁻⁵ M solution. Standard B solution was obtained by diluting the stock solution to 1×10⁻⁵ M. Both standards A and B were used for the CSP analysis.

Chiral Stationary Phases: The following ten CSPs were chosen for the study.

1) Astec Chirobiotic T, 10 μm

2) TBB-KROMASIL®-100° A

3) DMB-KROMASIL®-100° A

4) (S,S) ULMO

5) KROMASIL®-Chiral PM 821:II

6) (R)Alpha-Burke

7) (R,R) Beta-Gem

8) (S,S) Whelko-O

9) (3R, 4S) Pirkle-1J

10) L-Leucine

Automated Screening: Each of these CSPs (10 mg) were weighed into 8 mL SP cartridges and labeled. These cartridges were placed in a Bohdan Miniblock (rack), which was already defined on Gilson computer system. This rack was placed on Gilson 215 Liquid Handler. NEA pivalamide standard A solution (1 mL) was dispensed into each of the SP cartridges. The rack was removed from the Liquid Handler, and shaken for 30 minutes on an Orbital Shaker at room temperature. The solutions were drained into test tubes and decanted from test tubes into sample vials. Hexane was added to each sample vial to make up to the required volume (1.5 mL) for the HPLC analysis. The samples were submitted for HPLC analysis.

The procedure was repeated with NEA pivalamide standard B solution.

Results: The results of HPLC analysis are given below, along with the initial screening results used in the prior art.

| | Initial Screening | Combi Screening | |
|---|---|---|---|
| | (1 × 10⁻⁴ M) | Std. A | Std. B |
| Commercial CSP's | (Prior Art) | (5 × 10⁻⁵ M) | (1 × 10⁻⁵ M) |
| Astec Chirobiotic T | 1.01 | 1.68 | ND |
| Kromasil TBB | 1.00 | 1.03 | 1.10 |
| Kromasil DMB | 1.01 | 1.02 | 1.05 |
| (S, S) ULMO | 1.02 | 1.01 | 1.07 |
| Kromasil chiral PM | 1.01 | 1.03 | 1.02 |
| (R) Alpha-Burke | 1.56 | 1.46 | 2.45 |
| (R, R) Beta-GEM | 1.89 | 0.65 | 0.93 |
| (S, S) Whelk-O | 34.84 | 32.27 | 100.00 |
| (3R, 4S) Pirkle 1J | 1.56 | 0.95 | 1.39* |
| L-Leucine | 1.68 | 1.70 | 2.35* |

Conclusion: The results indicate that there is no significant difference between the initial screening using prior art methods and automated screening results. However, the SP cartridges used were not effective in filtering silica gel. Automation using Gilson 215 liquid handler worked without any problem. Incorporation of the following suggestions may enhance the efficiency of the process.

Suggestions:

1) The current demo SP cartridges were ineffective in filtering off the silica gel. SP cartridges with smaller pore size are required for this purpose, (which may slow down the process of filtration.)

2) Because filtration with smaller pore SP cartridges will be slow, the step of shaking for half an hour may be eliminated.

3) Instead of SP cartridges, fritted 48- or 96- well stationary phase plate may be used.

4) The fritted 48- or 96- well stationary phase plate may be prepacked with unique chiral stationary phases.

The sample required for the HPLC analysis is at least 1.5 mL. So, the standard solution dispensed should be 1.5-2 ml to avoid the extra step of addition of more solvent to the test vials. This also avoids further dilution of the sample.

### Example 2

Materials:

NEA pivalamide Standard: A stock solution (1×10⁻⁴ M) of racemate NEA pivalamide (2.55 mg ) was prepared by dissolving in hexane (100 mL).

Chiral Stationary Phases: The following ten CSPs were chosen for the study.

11) Astec Chirobiotic T, 10 μm

12) TBB-KROMASIL®-100° A

13) DMB-KROMASIL®-100° A

14) (S,S) ULMO

15)KROMASIL®-Chiral PM 821:II

16) (R)Alpha-Burke

17) (R,R) Beta-Gem

18) (S,S) Whelko-O

19) (3R, 4S) Pirkle-1J

20) L-Leucine

96-well Plates:

Oros 96-well plates fitted with 7-micron frits and 40 micron frits.

Automated Screening:

Experiment: Each of the above CSPs (10 mg) was weighed into 2 mL wells of Oros 96-well plate fitted with 7-micron frits and covered with 20-micron frits snugly on top of CSP.

Samples A: NEA pivalamide solution (1×10⁻⁴ M, 2 mL) was dispensed into each of the ten CSP wells and let drain gravitationally (˜30 minutes) into Marsh 96-well collection plate placed under the Oros plate. The samples were transferred into glass sample vials and submitted for chiral HPLC analysis.

The CSPs were washed with 20% solution of methanol in ethyl acetate (2×2 mL).

Samples B: The washed CSPs were treated again with NEA pivalamide solution (1×10⁻⁴ M) and the samples were submitted for chiral HPLC analysis.

Results: The results from the HPLC analysis are given below.

SAMPLE A

| | Enantiomer | Enantiomer | |
|---|---|---|---|
| CSP | #1 | #2 | Enantioselectivity |
| A1*-Astec Chirobiotic T | 5117 | 4576 | 1.12 |
| A1*-Astec Chirobiotic T | 5486 | 2884 | 1.90 |
| A2 Kromasil TBB | 811564 | 812500 | 1.00 |
| A2 Kromasil TBB | 815270 | 798278 | 1.02 |
| A3 Kromasil DMB | 853853 | 852534 | 1.00 |
| A3 Kromasil DMB | 849044 | 856960 | 0.99 |
| A4 (S, S) ULMO | 592179 | 596572 | 0.99 |
| A4 (S, S) ULMO | 592085 | 596011 | 0.99 |
| A5 Kromasil Chiral PM | 905180 | 900838 | 1.00 |
| A5 Kromasil Chiral PM | 918317 | 920910 | 1.00 |
| A6 (R) Alpha-Burke | 384957 | 217959 | 1.77 |
| A6 (R) Alpha-Burke | 374910 | 215646 | 1.74 |
| A7 (R, R) Beta-GEM | 95319 | 218657 | 0.44 |
| A7 (R, R) Beta-GEM | 87652 | 219491 | 0.40 |
| A8 (S, S) Whelk-O | 229016 | | |
| A8 (S, S) Whelk-O | 233983 | | |
| A9 (3R, 4S) Pirkle 1J | 5825 | 39503 | 0.15 |
| A9 (3R, 4S) Pirkle 1J | 4429 | 41813 | 0.11 |
| A10 L-Leucine | 136294 | 60824 | 2.24 |
| A10 L-Leucine | 133267 | 64026 | 2.08 |

SAMPLE B

| | Enantiomer | Enantiomer | |
|---|---|---|---|
| CSP | #1 | #2 | Enantioselectivity |
| B1-Astec Chirobiotic T | 1817 | 1347 | 1.35 |
| B1-Astec Chirobiotic T | 1588 | 1213 | 1.31 |
| B2 Kromasil TBB | 739947 | 736501 | 1.00 |
| B2 Kromasil TBB | 739065 | 735342 | 1.01 |
| B3 Kromasil DMB | 782058 | 777274 | 1.01 |
| B3 Kromasil DMB | 770775 | 763364 | 1.01 |
| B4 (S, S) ULMO | 415083 | 405852 | 1.02 |
| B4 (S, S) ULMO | 409164 | 405176 | 1.01 |
| B5 Kromasil Chiral PM | 784684 | 785289 | 1.00 |
| B5 Kromasil Chiral PM | 782716 | 774252 | 1.01 |
| B6 (R) Alpha-Burke | 89331 | 24500 | 3.65 |
| B6 (R) Alpha-Burke | 88420 | 25890 | 3.42 |
| B7 (R, R) Beta-GEM | 128996 | 196120 | 0.66 |
| B7 (R, R) Beta-GEM | 128806 | 194508 | 0.66 |
| B8 (S, S) Whelk-O | 9378 | ND | |
| B8 (S, S) Whelk-O | 9428 | | |
| B9 (3R, 4S) Pirkle 1J | ND | ND | |
| B9 (3R, 4S) Pirkle 1J | ND | ND | |
| B10 L-Leucine | 30896 | 7245 | 4.26 |
| B10 L-Leucine | 31479 | 6075 | 5.18 |

Conclusion:

The experiments with Oros plates pre-packed with CSPs are successful. The results were reproducible and consistent with the results obtained using other conventional methods. This new method of screening is simple and has the following advantages over the traditional methods that are currently practiced:

1) No incubation of racemate with the CSPs is required.

2) No shaking or agitation is needed.

3) Use of 96- or 48-well plate and corresponding 96- or 48-well collection plates reduces the number of steps in processing the samples.

4) The collection plate can be directly fed into HPLC analysis system, removing the requirement of manual transfer of the samples into 2 mL glass vials that are usually required for HPLC analysis.

5) The pre-packed CSP-plates can be used several times by implementing a washing protocol.

It is intended that the foregoing detailed description be regarded as illustrative rather than limiting and that it is understood that the following claims, including all equivalents, are intended to define the scope of the invention.

We claim:

1. A method for separation of racemic mixtures using a synthesizer, an analyzer, and a computer, the method including the steps of:
identifying physical variables that affect chiral selectivity for the separation of racemic mixtures, one of the physical variables being stationary phases;
determining a range of values of the physical variables;
choosing a finite number of experimental tests, wherein the experimental tests have values for the variables chosen from the range of values and wherein the experimental tests have test stationary phases;
providing a plurality of wells in a stationary phase plate and plurality of wells in a collection plate provided under the stationary phase plate;
assigning the test stationary phases to particular wells in the stationary phase plate;
packing the test stationary phases into the particular wells of the stationary phase plate;
dispensing the racemic mixture solution into the plurality of wells in the stationary phase plate, the racemic mixture concentration corresponding to the values chosen for the finite number of experimental tests;
allowing the racemic solution to pass through the stationary phases and collect into the corresponding wells in the collection plate;
analyzing, using the analyzer, racemic solutions collected in the plurality of wells in the collection plate; and
automatically generating suggested parameters for future experiments using the computer wherein the suggested parameters are chosen from a new range of values, the step of automatically generating being based on the analysis of the racemic solutions collected in the plurality of wells in the collection plate.

2. The method of claim 1, further comprising the step of generating a statistical analysis based on the analysis of the racemic solution collected in the plurality of wells in the collection plate, and
wherein the step of automatically generating suggested parameters for future experiments is based on the statistical analysis.

3. The method of claim 2, wherein the step of generating a statistical analysis is automatically generated using the computer.

4. The method of claim 3, wherein the step of generating a statistical analysis includes determining an optimal racemic solution, the optimal racemic solution having a highest selective adsorption.

5. The method of claim 1, further comprising the step of determining an optimal racemic solution, the optimal racemic solution having a highest selective adsorption;
wherein the stationary phases are classified based on characteristics, and
wherein the suggested parameters for future experiments include stationary phases with the same characteristics as the stationary phase used for the optimal racemic solution.

6. The method of claim 1, wherein the physical variables are selected from the group consisting of stationary phases, amount of stationary phase, racemic mixture solution concentration, and operating conditions.

7. The method of claim 1, wherein the physical variables include choice of solvents.

8. The method of claim 1, wherein the physical variables include solvent percentages.

9. The method of claim 1, wherein the step of analyzing the collected racemic solution in the plurality of wells in the collection plate includes determining enantiomeric excess.

10. The method of claim 1, wherein the step of washing the stationary phase plate is performed automatically.

11. The method of claim 1, wherein the step of packing the test stationary phases into the particular wells of the stationary phase plate includes packing the stationary phases into each well of the stationary phase plate sandwiched with a first frit and a second frit.

12. The method of claim 1, further comprising the steps of washing the stationary phase plate; and
re-using the stationary phase plate for the next experiment.

13. The method of claim 1, further comprising the steps of:
assigning stationary phases based on the suggested parameters to particular wells in the stationary phase plate;
packing the test stationary phases into the particular wells of the stationary phase plate;
dispensing the racemic mixture solution into the plurality of wells in the stationary phase plate, the racemic mixture concentration corresponds to the value chosen from a range of values;
allowing the racemic solution to pass through the stationary phases and collect into the corresponding wells in the collection plate; and
analyzing, using the analyzer, racemic solutions collected in the plurality of wells in the collection plate.

14. A method for optimizing chiral resolution using a synthesizer, an analyzer and a computer, the method including the steps of:
identifying variables which affect chiral selectivity for the separation of racemic mixtures;
choosing a finite number of experimental tests, wherein the experimental tests have values for the variables;
providing a plurality of wells in a stationary phase plate and plurality of wells in a collection plate provided under the stationary phase plate;
assigning each of the experimental tests to a particular well;
dispensing solvents into a plurality of wells chosen from the values for the experimental tests;
allowing the racemic solution to pass through the stationary phases and collect into the corresponding wells in the collection plate;
obtaining at least a portion of contents from the collection plate for the plurality of wells;
analyzing to determine the magnitude of chiral resolution for the at least a portion of the contents from the plurality of wells;
automatically generating a statistical analysis using the computer based on the step of determining the magnitude of chiral resolution and at least one of the variables identified in order to evaluate the chiral resolution in the wells; and
automatically generating, using the computer, suggested parameters for future experiments based on the statistical analysis.

15. The method of claim 14 wherein the step of analyzing to determine the magnitude of chiral resolution includes determining optical rotation of the at least a portion of the contents from the plurality of wells.

16. The method of claim 15 wherein the analyzer is a polarimeter.

17. The method of claim 15 wherein the analyzer is a chiral HPLC.

18. The method as claimed in claim 14 wherein one of the variables includes choice of solvents.

19. The method as claimed in claim 14 wherein one of the variables includes choice of stationary phases.

20. A method for optimizing chiral resolution using a synthesizer, an analyzer and a computer, the method including the steps of:
choosing test stationary phases from a library of potential stationary phases;
choosing a finite number of experimental tests, wherein the experimental tests have the test stationary phases chosen;
providing a plurality of wells in a stationary phase plate and plurality of wells in a collection plate provided under the stationary phase plate;
placing the test stationary phases in the stationary phase plate;
dispensing solvents into a plurality of wells chosen from the values for the experimental tests;
allowing the racemic solution to pass through the stationary phases and collect into the corresponding wells in the collection plate;
obtaining at least a portion of contents from the collection plate for the plurality of wells;
analyzing to determine the magnitude of chiral resolution for the at least a portion of the contents from the plurality of wells;
automatically generating a statistical analysis using the computer based on the step of determining the magnitude of chiral resolution and the test stationary phases in order to evaluate the chiral resolution in the wells; and
automatically generating, using the computer, suggested stationary phases for future experiments based on the statistical analysis, the suggested stationary phases being selected from the library of potential stationary phases and being different from the test stationary phases.
